(19) United States
(12) Patent Application Publication
(10) Pub. No.: US 2004/0234038 A1
(43) Pub. Date: Nov. 25, 2004

(54) X-ray cassette for medical x-ray imaging

(76) Inventors: Rolf Rathgeber, Tuusula (FI); Harri Konttila, Tuusula (FI)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/444,508

(22) Filed: May 23, 2003

(51) Int. Cl. G03B 42/04

(52) U.S. Cl. 378/182

(57) ABSTRACT

The invention relates to an X-ray cassette for a medical X-ray apparatus. The X-ray cassette has a mutually hinged top and bottom to define a housing structure, which includes opposite end faces and narrow side faces therebetween. Inside the housing structure is a cavity for accommodating a receiving means. The X-ray cassette is adapted to be placed in a cassette holder present in the X-ray apparatus for the duration of an Imaging session, said cassette holder including an X-ray cassette receiving slot in a shape substantially complementary to the X-ray cassette. The X-ray cassette comprises an one of its narrow side faces protruding guide elements offset from the longitudinal center line of the side face to lie closer to one of the main faces, said guide elements being adapted to fit in a complementary guide groove or guide recess formed in the receiving slot of a cassette holder, such that the X-ray cassette is insertable in the cassette holder in a specified position only.

### FIELD OF THE INVENTION

The present invention relates to an X-ray cassette for medical X-ray imaging, said X-ray cassette having a mutually hinged top and bottom to define a housing structure, which includes opposite end faces and narrow side faces therebetween and inside which housing structure is a space for installing a receiving means in the X-ray cassette, said X-ray cassette being adapted to be placed in a cassette holder present in an X-ray apparatus for the duration of an imaging session, said cassette holder including an X-ray cassette receiving slot in a shape substantially complementary to the X-ray cassette.

### BACKGROUND OF THE INVENTION

The receiving means in the X-ray cassette may comprise e.g. a processable film or a CR plate (Computed Radiography plate). Processable films are conventional and well known in the art and, thus, there is no need for detailed description. In general, computed radiography utilizes the principle that exposure of the storage phosphor to a radiographic image produces a corresponding latent image in the storage phosphor. If the storage phosphor is raster scanned (e.g. by means of laser) with light of a first wavelength, the latent image will be emitted as a light image at a second wavelength. The light emitted image is converted into an electronic (digital) radiographic image which can be stored, processed, displayed, and used to produce a hardcopy (film, paper) radiographic image.

This type of X-ray cassettes are known as such and widely used in a variety of X-ray equipment. However, one problem in existing X-ray cassettes is the possibility of inserting an X-ray cassette incorrectly in the receiving slot of a cassette holder despite instruction marks set on the X-ray cassette. For example, it is possible to put an X-ray cassette in a wrong way in a cassette holder, such that various elements present on the back face of the X-ray cassette, such as e.g. hinge elements, clamping elements, or the like, will be placed in the cassette holder towards an X-ray source and will be imaged on film or a CR plate, thus creating a need for re-imaging or, in the worst case scenario, leading to an incorrect procedure on a patient. Moreover, it is possible to place an X-ray cassette the right way relative to an X-ray source, yet upside down, whereby various locator marks present on the X-ray cassette will be imaged on film or a CR plate on the wrong side, leading to incorrect interpretations regarding the position of an imaged object and hence to targeting a possibly required procedure on a wrong object.

### SUMMARY OF THE INVENTION

Consequently, it is an object of the present invention to provide a relatively simple and reliable solution for ensuring proper positioning of an X-ray cassette in a cassette holder in view of overcoming the above problems. Another object is to provide a solution, which is readily adaptable to existing x-ray cassettes and cassette holders with minor modifications.

In order to achieve this object, an X-ray cassette of the invention comprises on one of its narrow side faces at least one protruding guide element offset from the longitudinal center line of the side face to lie closer to one of the main faces, said guide element being adapted to fit in a complementary guide groove or guide recess formed in the receiving slat of a cassette holder, such that the cassette is insertable in the cassette holder in a specified position only.

Said guide element may comprise two or more guide pins mounted on said side flank and spaced from each other in the longitudinal direction of the side face. The guide element may also comprise a guide bar extending at least over part of the length of the side face. The guide bar is preferably designed to extend over the entire length of the side face.

### BRIEF DESCRIPTION OF THE DRAWINGS

FIG. 1 shows an X-ray film cassette of the prior art in a schematic front view,

FIG. 2 shows the cassette of FIG. 1 in an opened condition,

FIG. 3 shows a cassette according to one embodiment of the invention in front, side, and plan views,

FIG. 4 shows a cassette according to a further second embodiment of the invention in front, side, and plan views,

FIG. 5 shows schematically one panoramic X-ray apparatus adaptable to a cassette solution of the invention, and

FIG. 6 shows schematically one recording device for patient information adaptable to a cassette solution of the invention.

### DETAILED DESCRIPTlON OF THE INVENTION

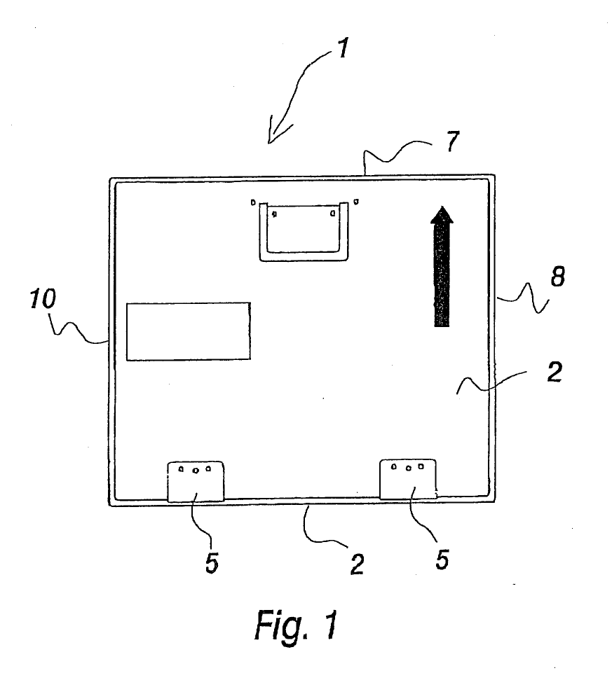

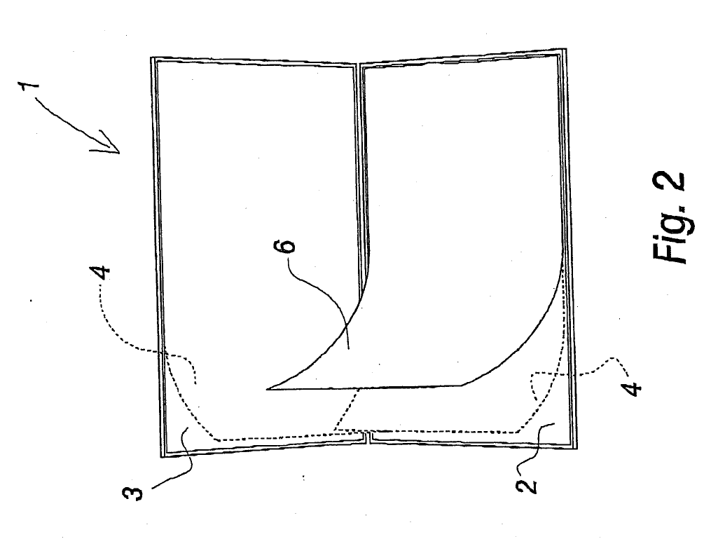

FIG. 1 illustrates a prior art X-ray film cassette 1 in a front view with the X-ray cassette in a closed condition and FIG. 2 shows the X-ray cassette in an opened condition. The X-ray cassette comprises a top 2 and a bottom 3, hinged to each other with hinges 5 for a housing structure which includes main faces defined by the top 2 and the bottom 3 and side faces 7-10 therebetween. Inside the housing structure is a cavity for an X-ray film 6, said cavity being also provided with reinforcement plates 4.

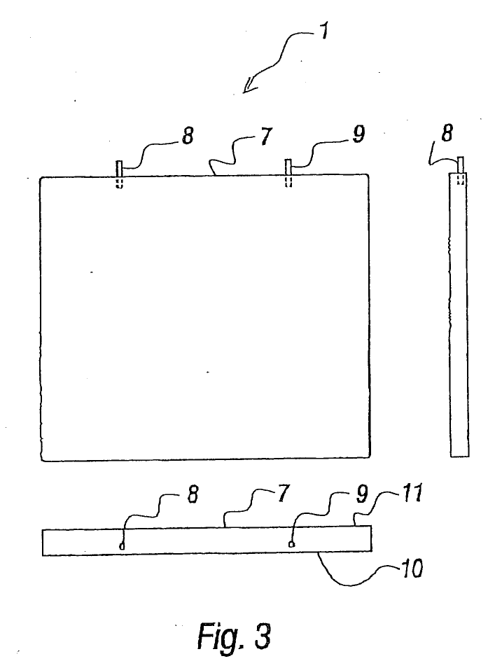

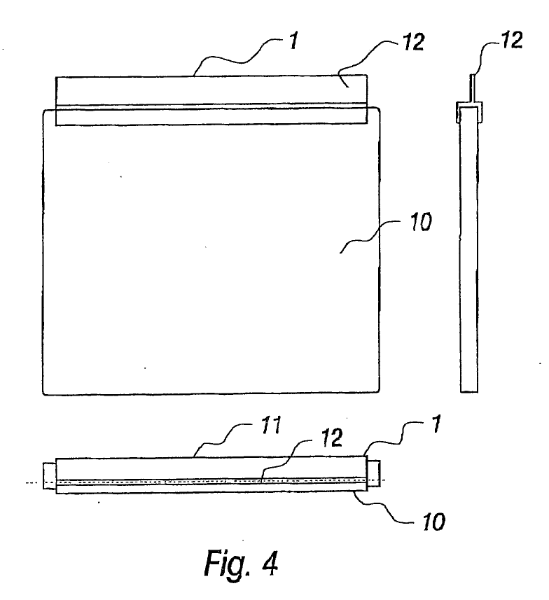

FIG. 3 illustrates an improved x-ray cassette 1 of the invention, which comprises opposite main faces 10, 11 and narrow side faces 7 therebetween. One side face 7 of the X-ray cassette 1 is formed with two guide pins 8, 9. The guide pins 8, 9 are positioned off-centrally in the lateral direction of the side face to lie closer to one main face 10 of the X-ray cassette, at a distance from each other in the longitudinal direction of the side face 7. The X-ray apparatus has the receiving slot of its cassette holder respectively formed with a recess located off-centrally in the lateral direction of the aperture, such that the X-ray cassette can be inserted in the receiving slot in one position only. FIG. 4 shows yet another embodiment, wherein the guide element comprises a bar 12 mounted off-centrally on the side face 7 and extending over the entire length of the X-ray cassette. It is conceivable that the bar 12 be designed to only extend over part of the length of an X-ray cassette or there may be two or more bars successively spaced from each other in the longitudinal direction of the side face 7. Instead of guide pins and bars, it is also conceivable to employ other forms of guide elements mounted off-centrally on one of the side faces of a cassette.

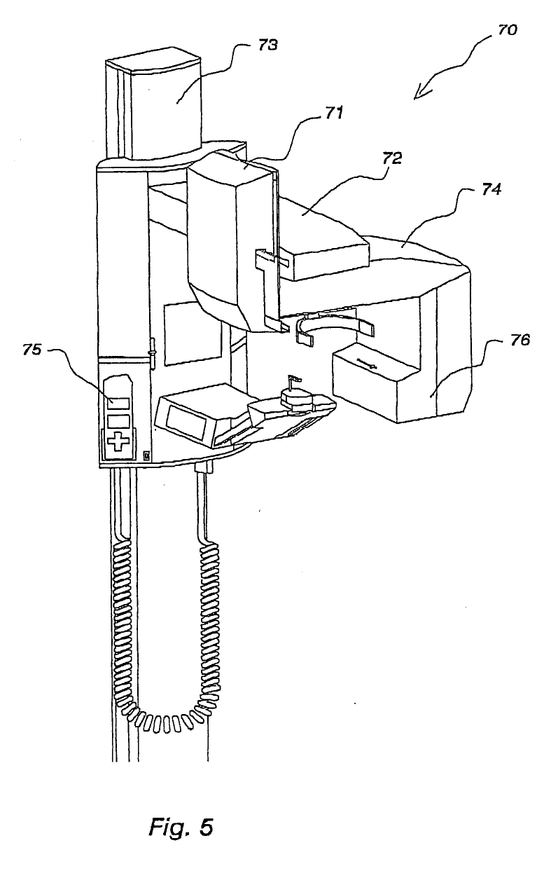

The invention can be applied for example in a panoramic X-ray apparatus 70 as shown in FIG. 5, which includes an upright column 73, and a bracket 72 movable up and down therealong and having mounted thereon a body section 74 of a C-frame, which is adapted to pivot relative to the bracket 72 around a vertical axis. One leg of the C-frame is provided with a source 76 of X-radiation and the other leg of the C-frame Is constituted by a cassette holder 71 movable vertically up and down relative to the body section 74 and having the X-ray cassette placed therein for the duration of an imaging session. A control panel is indicated by reference numeral 75. The bracket 72 is pivotable around a horizontal axis for setting the C-frame in a variety of angular positions and, indeed, the above terms the vertical axis of the body section 74 and vertical movement of the cassette holder are only given in reference to the service position depicted in FIG. 5.

The invention can also be applied e.g. in a cephalic X-ray apparatus or in a mammographic x-ray apparatus.

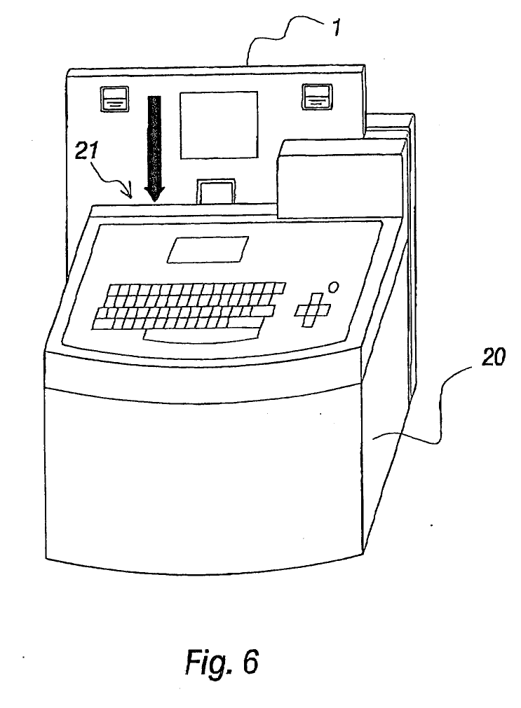

The invention can be applied also for example in a patient information recording device 20 as shown in FIG. 6, wherein the X-ray cassette is inserted in a receiving slot 21 which is provided With a spring-loaded floor element which yields down as the X-ray cassette is pushed in its position. During the downward pushing motion occurs the opening of an exposure aperture made in the X-ray cassette and provided with an openable lid for exposing the recorded information on film. Extracting the X-ray cassette by an upward motion causes the lid to close again. One problem with these devices has been the possibility of extracting the X-ray cassette by a horizontal motion in the middle of the upward movement as the lid of the exposure aperture is still open, whereby the exposure aperture may remain open and a film portion intended for recordings may be ruined by exposure. By using an X-ray cassette of the invention, provided e.g. with guide elements as shown in FIG. 3, and by forming the movable floor element of the X-ray cassette receiving space of a recording device with engagement recesses complementary to the guide elements, the lateral movement can be prevented in a simple manner.

Subject to minor modifications, the inventive solution Is adaptable to a plurality of existing X-ray cassettes and holders thereof. X-ray cassettes can be retrofitted with a desired guide element and the receiving slot can be subsequently provided with a necessary recess, or components constituting the receiving slot can be replaced by receiving slot components provided with a recess.

Instead of an X-ray film, the X-radiation receiving means may also comprise a CR plate.

Although the invention has been described above with reference to the accompanying figures and specification, the invention is by no means limited thereto but, instead, the invention can be varied within the scope afforded by the claims.

1. An X-ray cassette for medical X-ray imaging, said X-ray cassette having a mutually hinged top and bottom to define a housing structure, which includes opposite end faces and narrow side faces therebetween and inside which housing structure is a space for installing a receiving means in the X-ray cassette, said X-ray cassette being adapted to be placed in a cassette holder present in an X-ray apparatus for the duration of an imaging session, said cassette holder including an X-ray cassette receiving slot in a shape substantially complementary to the X-ray cassette, wherein the X-ray cassette comprises on one of its narrow side faces at least one protruding guide element offset from the longitudinal center line of the side face to lie closer to one of the main faces, said guide element being adapted to fit in a complementary guide groove or guide recess formed in the receiving slot of a cassette holder, such that the cassette is insertable in the cassette holder in a specified position only.

2. An X-ray cassette as set forth in claim 1, wherein the guide element comprises two or more guide pins mounted on said side flank and spaced from each other in the longitudinal direction of the side face.

3. An X-ray cassette as set forth in claim 1, wherein the guide element comprises a guide bar extending at least over part of the length of the side face.

4. An X-ray cassette as set forth in claim 3, wherein the guide bar extends preferably over the entire length of the side face.

5. An X-ray cassette as set forth in claim 1, wherein the X-ray apparatus comprises a panoramic X-ray apparatus.

6. An X-ray cassette as set forth in claim 1, wherein the X-ray apparatus comprises a cephalic X-ray apparatus.

7. An X-ray cassette as set forth in claim 1, wherein the X-ray apparatus comprises a mammographic X-ray apparatus.

8. An X-ray cassette as set forth in claim 1, wherein the X-radiation receiving means comprises an X-ray film.

9. An X-ray cassette as set forth in claim 1, wherein the X-radiation receiving means comprises a CR plate (Computed Radiography plate).
